(19) United States
(12) Patent Application Publication
(10) Pub. No.: US 2010/0314137 A1
(43) Pub. Date: Dec. 16, 2010

(54) Fire fighting foam proportioning devices and systems having improved low flow performance

(75) Inventors: Eldon D. Jackson, Arlington, TX (US); Kenneth C. Baker, Mansfield, TX (US)

Correspondence Address: ROGER BURLEIGH, 2925 STATE STREET, DALLAS, TX, 75204, US

(73) Assignee: Chemguard Inc.

(21) Appl. No.: 12/456,374

(22) Filed: Jun. 16, 2009

(51) Int. Cl. A62C 31/00; G05D 11/00

(52) U.S. Cl. 169/15; 137/100

(57) ABSTRACT

Improved fire fighting foam proportioning devices and systems include an improved ratio controller and an improved bladder tank. The improved ratio controller is characterized by a modified foam concentrate metering orifice disposed in a foam concentrate inlet proximate to an annular low pressure chamber, the metering orifice having a central circular passage having a length at least 50 per cent of the diameter of the passage, the improved orifice decreasing the turbulence of foam concentrate and providing a smoother flow transition into the annular low pressure chamber. The improved bladder tank is characterized by a modified discharge tube having a plurality of holes disposed along its length, wherein the combined area of holes per foot of length is at least 50 per cent of the inner diameter of the discharge tube.

### TECHNICAL FIELD OF THE INVENTION

The present invention is directed, in general, to firefighting equipment and, more specifically, to fire fighting foam proportioning devices and systems having improved low flow performance.

### BACKGROUND OF THE INVENTION

The addition of a foam concentrate to a water stream is often used to fight flammable liquid fires in industrial factories, chemical plants, petrochemical plants and petroleum refineries. The foam concentrate must be added at a constant proportion to the water stream. When the foam/water solution is delivered, it generates foam which extinguishes the flames more effectively than by the application of water alone.

For different applications, foam concentrates are designed to be accurately mixed with water in specific proportions, such as 1%, 3% or 6% foam-to-water ratios. Proportioning equipment, foam concentrate, and discharge equipment must be matched to produce the proper concentration at system design operating pressures. If the system adds too much foam concentrate, the resulting foam viscosity is greater than desired, thereby limiting the ability of the foam to be spread on the fire and diminishing the fire-extinguishing quality. Furthermore, the addition of excessive amounts of concentrate to the water stream increases the cost of the use of the foam and the frequency at which the foam concentrate supply must be replenished.

There are two currently available types of foam proportioning systems. One type involves the drawing of the foam-forming concentrate into the water stream by an in-line or by-pass foam eductor. Two problems are associated with such eductor devices. First, the foam-to-water ratio is at times not accurate. Second, eductor devices create a substantial pressure drop across the eductor, which limits the flow through the system. The second type of system is commonly referred to as a balanced pressure proportioning system. Balanced pressure proportioning systems supply foam concentrate to the water stream under pressure and, as a result, the pressure drop across the eductor is reduced.

One type of balanced pressure proportioning system utilizes a foam concentrate bladder tank and a foam proportioner, or ratio controller, to mix foam concentrate with a primary water stream. A balanced pressure bladder tank includes a pressure vessel having an internal flexible bladder for holding a supply of foam concentrate. Water is supplied to the region intermediate to the pressure vessel and the flexible bladder from a main water supply. The bladder tank has a perforated discharge tube within the flexible bladder that is coupled through the inner bladder to a discharge outlet on the pressure vessel. The discharge tube includes small holes whereby foam concentrate is pushed through the holes and out through the discharge outlet as water pressure is applied to the outside of the flexible bladder. The foam concentrate is then forced through a concentrate pipe toward the ratio controller.

The ratio controller includes a foam concentrate inlet having a foam concentrate metering orifice and a water inlet orifice. As water flows through the ratio controller, a low pressure region is created which causes foam concentrate to pass into the water stream as required to balance the flow and pressure based on the metering orifice; the metering orifice is sized for the flow of the firefighting system and the foam concentrate mixing ratio. As water demand increases in the system, the foam concentrate flow also increases in order to maintain the proper mixing ratio.

Conventional balanced pressure bladder tank systems known in the art are often used with open deluge systems having multiple small discharge devices or a single large device. Such systems have a fixed flow rate in gallons per minute and the ratio controller is sized to fall in the mid to maximum flow rate for the system; the flow rate is a function of the number of discharge devices that simultaneously open. The discharge devices (i.e., nozzles or sprinklers) are evenly positioned over a protected area for even distribution of foam/water solution. Each discharge device includes a thermal trigger that keeps the device closed until the proximate temperature increases to the design limit.

In accordance with current National Fire Protection Association (NFPA) minimum standards, foam concentrate must be proportioned at the rated percentage in a system when only four discharge devices are in operation; i.e., a system must properly proportion foam concentrate at low flow rates. Where the proper foam mixture of 1%, 3% or 6% must be met at a four sprinkler flow rate to the system, this is typically 60-120 gallons per minute (GPM). In a typical system, when the foam/water solution is flowing at the minimum approved flow rate for the ratio controller, the foam percentage often can be lean; i.e., less than the recommended percentage. To overcome this problem, some prior art systems utilize multiple ratio controllers of smaller size or a complex variable-pressure type ratio controller having multiple moving components and very high pressure loss. The use of multiple or complex mechanical ratio controllers, however, increases system costs and the potential for mechanical failures. Accordingly, there is a need in the art for improved fire fighting foam proportioning devices and systems; such devices and systems should be of simple design and sufficient to meet NFPA operational requirements for low flow rates.

### SUMMARY OF THE INVENTION

To address the deficiencies of the prior art, disclosed are improved fire fighting foam proportioning devices and systems including an improved ratio controller and an improved bladder tank. The improved ratio controller is characterized by: a venturi body having a throat portion and a diffuser portion; a water inlet orifice coupled to the venturi body upstream to the throat portion for receiving a stream of water, wherein the water inlet orifice and the throat portion of the venturi body form an annular low pressure chamber having an inner circumferential passage for fluid communication of a foam concentrate from the annular low pressure chamber into the stream of water; a foam concentrate inlet to the annular low pressure chamber for receiving foam concentrate; and, a non-adjustable foam concentrate metering orifice disposed in the foam concentrate inlet proximate to the annular low pressure chamber, the metering orifice having a central circular passage having a length at least 50 per cent of the diameter of the passage in order to decrease the turbulence of foam concentrate and provide a smoother flow transition into the annular low pressure chamber. In an exemplary embodiment, the foam concentrate inlet of the ratio controller comprises a cylindrical portion terminating at an inwardly-extending lip forming an opening into the annular low pressure chamber, the foam concentrate metering orifice having an outer diameter less than the foam concentrate inlet and greater than the opening into the annular low pressure chamber. The foam concentrate metering orifice can have a central body extending through the opening into the annular low pressure chamber and an outwardly-extending lip that abuts the inwardly-extending lip of the foam concentrate inlet.

The improved bladder tank comprises: a pressure vessel; a flexible inner bladder for holding a supply of foam concentrate; and, a modified discharge tube disposed within the inner bladder, wherein the discharge tube comprises a plurality of holes disposed along its length and wherein the combined area of holes per foot of length is at least 50 per cent of the inner diameter of the perforated tube. In an exemplary embodiment, the discharge tube of the improved bladder tank has a diameter in the range of 2 to 4 inches and the holes have a diameter in the range of ⅝ to ¾ inches.

In certain system implementations, the bladder tank is coupled to the water supply pipe at an upstream point remote to the ratio controller, wherein one or more valves in the water supply pipe leading to the ratio controller are downstream from the point at which the bladder tank is coupled to the water supply pipe; this modification of conventional system design provides a lower pressure loss differential from the water supply to the bladder tank and the foam concentrate inlet of the ratio controller. In other system implementations, a balancing valve can be utilized intermediate to a foam discharge outlet of the bladder tank and the foam concentrate inlet of the ratio controller, wherein the balancing valve senses the pressure of the water supply proximate to the ratio controller and lowers the foam concentrate pressure to substantially equal the water supply pressure.

The foregoing has outlined, rather broadly, the principles of the present invention so that those skilled in the art may better understand the detailed description of the exemplary embodiments that follow. Those skilled in the art should appreciate that they can readily use the disclosed conception and exemplary embodiments as a basis for designing or modifying other structures and methods for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following detailed description taken in conjunction with the accompanying drawings, in which:

FIG. 1 illustrates a cross-sectional view of a prior art ratio controller;

FIG. 2 illustrates a cross-sectional view of an improved ratio controller;

FIG. 3 illustrates a cut-away view of an improved bladder tank;

FIG. 4 illustrates a functional schematic of an exemplary balanced pressure bladder tank firefighting system utilizing the improved ratio controller and improved bladder tank; and,

FIG. 5 illustrates a functional schematic of an exemplary positive pressure firefighting system utilizing the improved ratio controller.

### DETAILED DESCRIPTION

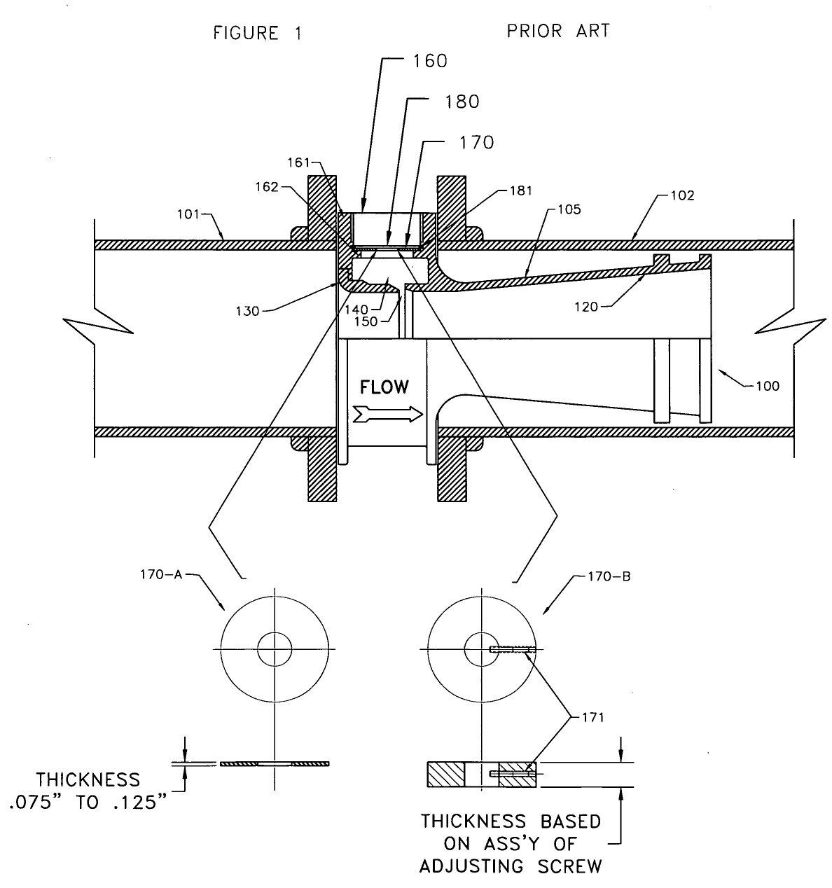

Referring to FIG. 1, illustrated is a cross-sectional view of a prior art ratio controller 100; the ratio controller is illustrated in a mounted configuration between an inlet water pipe 101 and a discharge pipe 102. The ratio controller 100 is characterized by a venturi body 105 having a throat portion 110 and a diffuser portion 120; as those skilled in the art understand, a venturi is a device that consists of a gradually decreasing throat portion through which fluid in a pipe is accelerated, followed by a gradually increasing diffuser portion that allows the fluid to nearly regain its original pressure head. The ratio controller 100 further includes a water inlet orifice 130 coupled to the venturi body 105 upstream to the throat portion 110 for receiving a stream of water from inlet water pipe 101; the water inlet orifice 130 and venturi body 105 can be coupled, for example, by threaded means or brazing or soldering. The water inlet orifice 130 and the throat portion 110 of the venturi body form an annular low pressure chamber 140 having an inner circumferential passage 150 for fluid communication of a foam concentrate from the annular low pressure chamber 140 into a stream of water introduced through inlet water pipe 101. The ratio controller further includes a foam concentrate inlet 160 to the annular low pressure chamber 140 for receiving foam concentrate from a foam concentrate supply pipe (not shown). The foam concentrate inlet 160 comprises a cylindrical portion 161 terminating at an inwardly-extending lip 162 forming an opening into said annular low pressure chamber 140. Finally, a foam concentrate metering orifice 170 having an outer diameter less than the foam concentrate inlet 160 and greater than the opening into the annular low pressure chamber 140 is positioned against the inwardly-extending lip 162 and secured with a retaining ring 180 which is fitted into a retaining slot 181 in the wall of the foam concentrate inlet 160.

According to the prior art, ratio controllers of the design type illustrated in FIG. 1 utilize a metering orifice of either a non-adjustable type 170-A or an adjustable type 170-B. Both types consist of a metal disc having a central circular passage having a diameter selected as a function of the ratio of foam-to-water to be used in the firefighting system. The adjustable type 170-B includes an adjusting screw 171 that can be selectively extended into the central circular passage to restrict the flow of foam concentrate through the orifice. The non-adjustable type 170-A is typically characterized by a thickness in the range of 0.075 to 0.125 inches, while the adjustable type 170-B has a thickness that is a function of the size of adjusting screw 171. It has been found that both of these prior art designs are non-optimal when it is desired, or necessary, to accurately meter foam concentrate into a water stream at low flow rates.

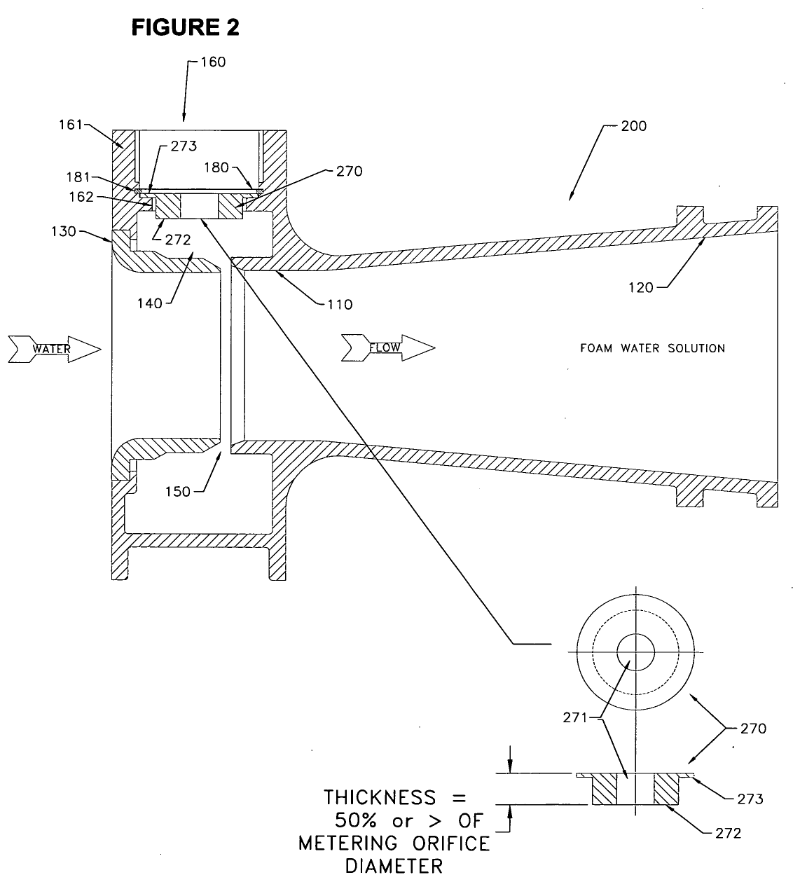

Turning now to FIG. 2, illustrated is a cross-sectional view of an improved ratio controller 200 that overcomes deficiencies in the prior art design illustrated in FIG. 1. The improved ratio controller is structurally identical to the prior art ratio controller 100 except for the foam concentrate metering orifice 270; reference numerals in FIG. 2 identical to those in FIG. 1 denote the same elements. The foam concentrate metering orifice 270 has an improved design characterized by a central circular passage 271 having a length at least 50 per cent of the diameter of the passage; i.e., the thickness of the metering orifice is at least 50 per cent of the diameter of the passage. In comparison to the operational characteristics of the prior art metering orifice designs (170-A, 170-B), it has been found that the increased length of the central circular passage 271 decreases the turbulence of foam concentrate and provides a smoother flow transition into the annular low pressure chamber 140. The absence of an adjusting screw 171 also eliminates a source of turbulence. The improved operation of the ratio controller 200 contributes to the capability to operate a firefighting system at lower flow rates while maintaining accurate foam-to-water ratios.

In an exemplary embodiment, the improved foam concentrate metering orifice 270 has a central body 272 that extends through the opening into the annular low pressure chamber 140, and an outwardly-extending lip 273 that abuts the inwardly-extending lip 162 of the foam concentrate inlet 160. This embodiment of the foam concentrate metering orifice 270 provides the capability to easily retrofit existing ratio controllers since it does not require a change to the position of the retaining ring 180; i.e., the thickness of the outwardly-extending lip 273 can have the same thickness as the prior art foam concentrate metering orifice 170, while the increase in the length of the passage through the orifice is accommodated by the extension of the central body 272 through the opening in the annular low pressure chamber 140. For newly-designed ratio controllers, the greater thickness of the foam concentrate metering orifice 270 can be alternatively accommodated with an appropriate relocation of the retaining slot 181 in the wall of the foam concentrate inlet 160. Because of the thicker profile of a foam concentrate metering orifice according to the principles of the invention, another alternative for newly-designed ratio controllers would be for the metering orifice to have external threads with an appropriately-threaded receiving portion within foam concentrate inlet 160. Those skilled in the art will appreciate that an improved foam concentrate metering orifice according to the principles of the invention could also be press-fit or otherwise secured within the foam concentrate inlet 160; it is intended that all such means of securing the improved foam concentrate metering orifice be within the scope of the claims.

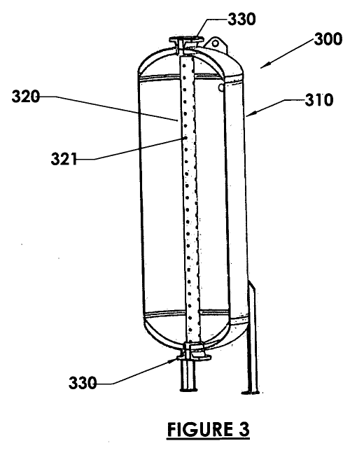

Referring now to FIG. 3, illustrated is a cut-away view of an improved bladder tank 300. The bladder tank 300 includes a pressure vessel 310 that holds a flexible inner bladder (not shown) for holding a supply of foam concentrate. A discharge tube 320 is disposed within the inner bladder and at least one end of the discharge tube 320 is coupled through the inner bladder to a foam discharge outlet 330 mounted to the external surface of the pressure vessel 310. The discharge tube 320 comprises a plurality of holes (generally designated 321) disposed along its length. In operation, water is supplied to the region between the pressure vessel 310 and the outside of the flexible bladder; the water exerts pressure on the flexible bladder and foam concentrate is pushed through the holes in the discharge tube and out through the foam discharge outlet 330 from where it can be supplied to the ratio controller 200. The improved bladder tank 300 corresponds to the general design of a conventional vertical tank. Those skilled in the art, however, will recognize that a conventional horizontal tank, which further includes a second discharge tube perpendicular to discharge tube 320 with a cross fitting between the tubes, can be modified in accordance with the design principles disclosed herein to improve low flow operation.

According to known prior art designs, the holes are typically approximately ½ inch in diameter and the combined area of holes per foot of length is approximately 25 per cent of the internal diameter of the discharge tube. It has been found, however, that the pressure drop in the foam concentrate supply to the ratio controller is minimized, and the flow characteristics of foam concentrate out of the bladder tank are optimized, if the combined area of holes per foot of length is at least 50 per cent of the inner diameter of the discharge tube 320. In an exemplary embodiment, the discharge tube 320 of the improved bladder tank 300 has a diameter in the range of 2 to 4 inches and the holes have a diameter in the range of ⅝ to ¾ inches.

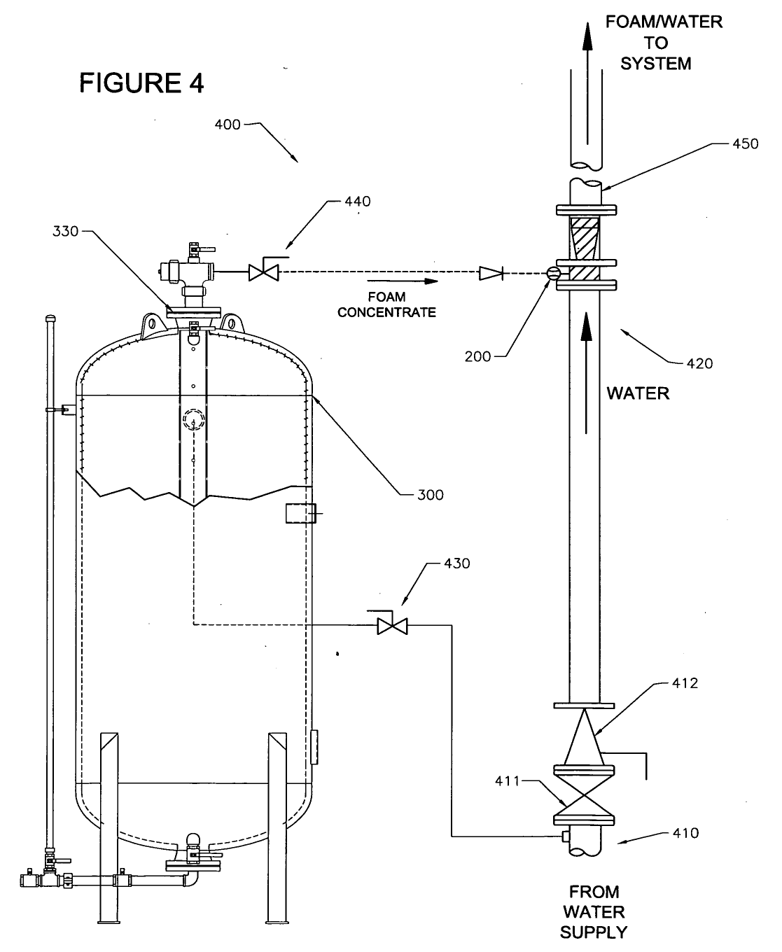

Now turning to FIG. 4, illustrated is a basic functional schematic of an exemplary balanced pressure bladder tank firefighting system 400 utilizing the improved ratio controller 200 and improved bladder tank 300 illustrated in FIGS. 2 and 3, respectively. Those skilled in the art will recognize that, in practice, the firefighting system 400 can include additional elements, such as strainers, control valves, drain/fill valves, gauges, etc., which are not relevant to an understanding of the principles of the invention disclosed herein.

The firefighting system 400 includes a water supply pipe 410 for receiving a primary flow of water. The water supply pipe 410 is coupled to a water supply control valve 411 upstream from the water inlet of the ratio controller 200. In the illustrated system, an alarm check valve 412 is included intermediate to the water supply control valve 411 and the water inlet of ratio controller 200; the alarm check valve prevents the reverse flow of water from the firefighting system to the water supply.

The water supply must also be coupled to the bladder tank 300. In prior art systems, the water supply to provide motive pressure to the bladder tank 300 is typically taken from a location 420 immediately upstream of the ratio controller 200. In the exemplary system illustrated in FIG. 4, however, the bladder tank 300 is coupled to the water supply pipe 410 at a remote location upstream from the ratio controller; i.e., prior to the water supply control valve 411 and the alarm check valve 412. In this embodiment, valves in the water supply pipe leading to the water inlet of ratio controller 200 are downstream from the point at which the bladder tank 300 is coupled to the water supply pipe 410; this modification of conventional system design provides a lower pressure loss differential from the water supply to the bladder tank 300 and the foam concentrate inlet of the ratio controller 200, improving the low flow rate operation of the system. The water supply line from the water supply pipe 410 to the bladder tank includes a control valve 430; the valve is normally open but can be closed for system servicing.

The foam concentrate inlet of ratio controller 200 is coupled to the foam discharge outlet 330 of bladder tank 300. In the exemplary system illustrated, the foam supply line from the foam discharge outlet 330 of bladder tank 300 includes a control valve 440; the valve is normally open but can be closed for system servicing.

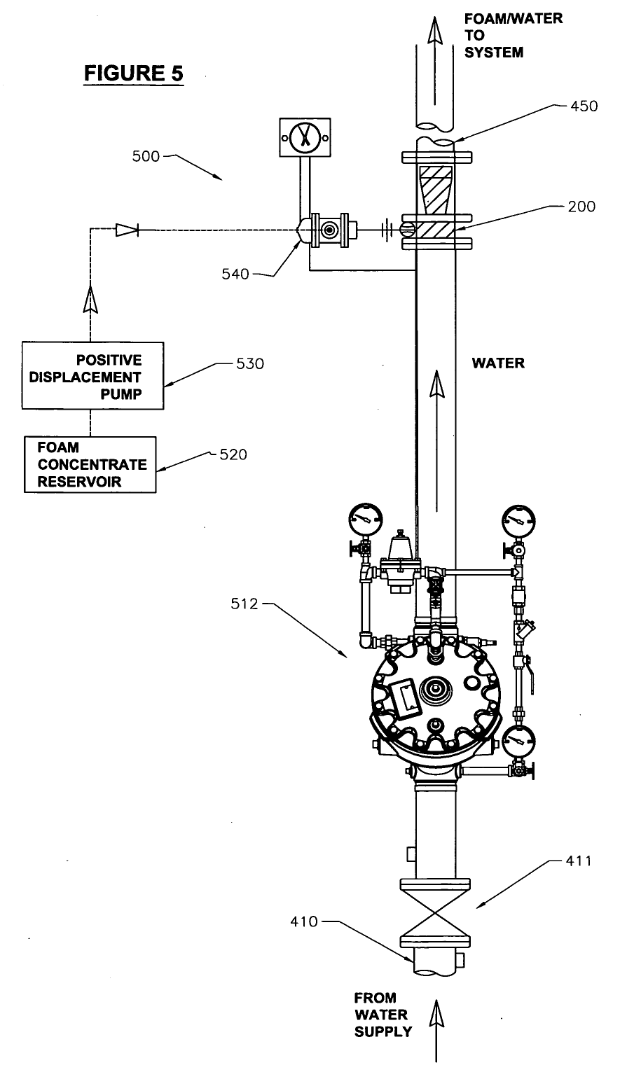

Finally, FIG. 5 illustrates a basic functional schematic of an exemplary positive pressure proportioning fire firefighting system 500 utilizing the improved ratio controller 200 illustrated in FIG. 2. Those skilled in the art will recognize that, in practice, the firefighting system 500 can include additional elements, such as strainers, control valves, drain/fill valves, gauges, etc., which are not relevant to an understanding of the principles of the invention disclosed herein.

The firefighting system 500 includes a water supply pipe 410 for receiving a primary flow of water. The water supply pipe 410 is coupled to a water supply control valve 411 upstream from the water inlet of the ratio controller 200. In the illustrated system, a pressure control assembly 512 is included intermediate to the water supply control valve 411 and the water inlet of ratio controller 200; the pressure control assembly 512 is used to control the water pressure supplied to the ratio controller 200. The purpose of controlling the water pressure is due to variable water supply pressure that at initial operation of the system can be high and will require more foam concentrate; by controlling the pressure, the system discharge is controlled as required for proper operation.

The firefighting system 500, rather than utilizing a bladder tank for delivering foam concentrate to the ratio controller 200, further includes a foam concentrate reservoir 520 and a positive displacement foam concentrate pump 530 coupled to the foam concentrate reservoir for supplying foam concentrate at a higher pressure than the flow of water to the ratio controller 200. This allows the foam concentrate reservoir 520 to be at a greater distance from the point of application and also allows the use of multiple discharge systems with a single foam concentrate supply. As the system water pressures can vary due to demand, the ratio controller 200 can still proportion foam concentrate into the water supply at all points at the proper percentage. A balancing valve 540 is coupled intermediate to the positive displacement foam concentrate pump 530 and the foam concentrate inlet of the ratio controller 200; the balancing valve 540 senses the pressures of the water supply and the foam concentrate to the ratio controller 200 and opens to bypass foam concentrate back to the foam concentrate reservoir 520 until the pressure of the foam concentrate is substantially equal to the water supply pressure.

The principles disclosed herein provide significant improvements to the art of fire fighting foam proportioning devices and systems, particularly to the capability of the improved ratio controller and bladder tank to contribute to the operation of such systems at low flow rates. In prior art designs of this type system, the minimum flow rate where the proper foam percentage was obtainable was much higher than allowed for a four discharge device flow rate as required by the NFPA. Utilizing the design principles disclosed herein, however, a system can provide very low flow rates (e.g., less than 60 gpm).

Although the present invention has been described in detail, those skilled in the art will conceive of various changes, substitutions and alterations to the exemplary embodiments described herein without departing from the spirit and scope of the invention in its broadest form. The exemplary embodiments presented herein illustrate the principles of the invention and are not intended to be exhaustive or to limit the invention to the form disclosed; it is intended that the scope of the invention be limited only to the claims appended hereto, and their equivalents.

What is claimed is:

1. A foam proportioning system used to mix foam concentrate with a stream of water to produce a foam/water mixture for firefighting purposes, said system comprising:
a ratio controller comprising:
a venturi body having a throat portion and a diffuser portion;
a water inlet orifice coupled to said venturi body upstream to said throat portion for receiving a stream of water, wherein said water inlet orifice and said throat portion of said venturi body form an annular low pressure chamber having an inner circumferential passage for fluid communication of a foam concentrate from said annular low pressure chamber into said stream of water;
a foam concentrate inlet to said annular low pressure chamber for receiving said foam concentrate; and,
a non-adjustable foam concentrate metering orifice disposed in said foam concentrate inlet proximate to said annular low pressure chamber, said metering orifice having a central circular passage having a length at least 50 per cent of the diameter of said passage in order to decrease the turbulence of said foam concentrate and provide a smoother flow transition into said annular low pressure chamber.

2. The foam proportioning system recited in claim 1, wherein said foam concentrate inlet comprises a cylindrical portion terminating at an inwardly-extending lip forming an opening into said annular low pressure chamber, said foam concentrate metering orifice having an outer diameter less than said foam concentrate inlet and greater than said opening into said annular low pressure chamber.

3. The foam proportioning system recited in claim 2, wherein said foam concentrate metering orifice comprises a central body extending through said opening into said annular low pressure chamber and an outwardly-extending lip that abuts said inwardly-extending lip of said foam concentrate inlet.

4. The foam proportioning system recited in claim 1., further comprising a bladder tank for supplying said foam concentrate to said ratio controller, said bladder tank comprising:
a pressure vessel;
a flexible inner bladder for holding a supply of said foam concentrate; and,
a discharge tube disposed within said inner bladder, at least one end of said discharge tube being coupled through said inner bladder to a foam discharge outlet mounted to the external surface of said pressure vessel, wherein said discharge tube comprises a plurality of holes disposed along its length and wherein the combined area of said holes per foot of length is at least 50 per cent of the inner diameter of said perforated tube.

5. The foam proportioning system recited in claim 2, wherein said discharge tube has a diameter in the range of 2 to 4 inches and said holes have a diameter in the range of ⅝ to ¾ inches.

6. A foam firefighting system, comprising:
a water supply pipe for receiving a primary flow of water;
a bladder tank comprising a pressure vessel coupled to said water supply pipe, a flexible inner bladder for holding a supply of foam concentrate, and a discharge tube disposed within said inner bladder, at least one end of said discharge tube being coupled through said inner bladder to a foam discharge outlet mounted to the external surface of said pressure vessel wherein, as water enters said pressure vessel from said water supply inlet, said foam concentrate is forced from said bladder in proportion to the pressure under which said water enters said pressure vessel; and
a ratio controller coupled to said water supply pipe and said foam discharge outlet of said bladder tank for receiving a flow of water and a flow of said foam concentrate, said ratio controller comprising:
a venturi body having a throat portion and a diffuser portion;
a water inlet nozzle coupled to said venturi body upstream to said throat portion for receiving a stream of water from said water supply pipe, wherein said water inlet nozzle and said throat portion of said venturi body form an annular low pressure chamber having an inner circumferential passage for fluid communication of a foam concentrate from said annular low pressure chamber into said stream of water;
a foam concentrate inlet to said annular low pressure chamber for receiving said foam concentrate from said foam discharge outlet of said bladder tank; and,
a non-adjustable foam concentrate metering orifice disposed in said foam concentrate inlet proximate to said annular low pressure chamber, said metering orifice having a thickness at least 50 per cent of the diameter of said orifice in order to decrease the turbulence of said foam concentrate and provide a smoother flow transition into said annular low pressure chamber.

7. The foam firefighting system recited in claim 6, wherein said foam concentrate inlet comprises a cylindrical portion terminating at an inwardly-extending lip forming an opening into said annular low pressure chamber, said foam concentrate metering orifice having an outer diameter less than said foam concentrate inlet and greater than said opening into said annular low pressure chamber.

8. The foam firefighting system recited in claim 7, wherein said foam concentrate metering orifice comprises a central body extending through said opening into said annular low pressure chamber and an outwardly-extending lip that abuts said inwardly-extending lip of said foam concentrate inlet.

9. The foam firefighting system recited in claim 6, wherein said discharge tube of said bladder tank comprises a plurality of holes disposed along its length and wherein the combined area of said holes per foot of length is at least 50 per cent of the inner diameter of said discharge tube.

10. The foam firefighting system recited in claim 9, wherein said discharge tube has an inner diameter in the range of 2 to 4 inches and said holes have a diameter in the range of ⅝ to ¾ inches.

11. The foam firefighting system recited in claim 6, wherein said bladder tank is coupled to said water supply pipe at an upstream point remote to said ratio controller, wherein one or more valves in said water supply pipe leading to said ratio controller are downstream from the point at which said bladder tank is coupled to said water supply pipe.

12. The foam firefighting system recited in claim 6., further comprising a balancing valve intermediate to said foam discharge outlet of said bladder tank and said ratio controller foam concentrate inlet, wherein said balancing valve senses the pressure of said water supply proximate to said ratio controller and lowers the foam concentrate pressure to substantially equal said water supply pressure.

13. A foam firefighting system, comprising:
a water supply pipe for receiving a flow of water;
a foam concentrate reservoir;
a positive displacement foam concentrate pump coupled to said foam concentrate reservoir for supplying foam concentrate at a higher pressure than said flow of water;
a ratio controller coupled to said water supply pipe and said positive displacement foam concentrate pump for receiving a flow of water and a flow of said foam concentrate, said ratio controller comprising:
a venturi body having a throat portion and a diffuser portion;
a water inlet nozzle coupled to said venturi body upstream to said throat portion for receiving a stream of water from said water supply pipe, wherein said water inlet nozzle and said throat portion of said venturi body form an annular low pressure chamber having an inner circumferential passage for fluid communication of a foam concentrate from said annular low pressure chamber into said stream of water;
a foam concentrate inlet to said annular low pressure chamber for receiving said foam concentrate from said positive displacement foam concentrate pump; and,
a non-adjustable foam concentrate metering orifice disposed in said foam concentrate inlet proximate to said annular low pressure chamber, said metering orifice having a thickness at least 50 per cent of the diameter of said orifice in order to decrease the turbulence of said foam concentrate and provide a smoother flow transition into said annular low pressure chamber; and,
a balancing valve coupled intermediate to said positive displacement foam concentrate pump and said foam concentrate inlet of said ratio controller, wherein said balancing valve senses the pressures of said water supply and said foam concentrate to said ratio controller and opens to bypass foam concentrate back to said foam concentrate reservoir until the pressure of said foam concentrate is substantially equal to said water supply pressure.

14. The foam firefighting system recited in claim 13, wherein said foam concentrate inlet comprises a cylindrical portion terminating at an inwardly-extending lip forming an opening into said annular low pressure chamber, said foam concentrate metering orifice having an outer diameter less than said foam concentrate inlet and greater than said opening into said annular low pressure chamber.

15. The foam firefighting system recited in claim 14, wherein said foam concentrate metering orifice comprises a central body extending through said opening into said annular low pressure chamber and an outwardly-extending lip that abuts said inwardly-extending lip of said foam concentrate inlet.
